(19) United States
(12) Patent Application Publication
(10) Pub. No.: US 2025/0238866 A1
(43) Pub. Date: Jul. 24, 2025

(54) SYSTEM AND METHOD FOR REAL-TIME SPOT PRICE VOLATILITY SURFACE PREDICTION

(71) Applicant: JPMorgan Chase Bank, N.A., New York, NY (US)

(72) Inventors: Kai NI, Basking Ridge, NJ (US); Charlie CHE, Ridgewood, NJ (US); Hanxuan LIN, Shanghai (CN); Guofan HU, New York, NY (US)

(73) Assignee: JPMorgan Chase Bank, N.A., New York, NY (US)

(21) Appl. No.: 18/417,757

(22) Filed: Jan. 19, 2024

(51) Int. Cl. G06Q 40/06; G06F 16/2458

(52) U.S. Cl. CPC G06Q 40/06; G06F 16/2474

(57) ABSTRACT

Various methods and processes, apparatuses/systems, and media for data processing are disclosed. A processor accesses a database that stores a plurality of historical data and input data corresponding to a derivative instrument; implements an artificial intelligence deep learning model; trains the artificial intelligence deep learning model with the historical data and the input data corresponding to the derivative instrument for time-series data prediction; learns, in response to training, volatility surface deformation data over time corresponding to the derivative instrument; calculates spot sensitivity data of the derivative instrument based on the volatility surface deformation data output from the artificial intelligence deep learning model; displays the spot sensitivity data onto a user interface; and receives user input via the user interface to conduct a transaction with respect to the derivative instrument.

### TECHNICAL FIELD

This disclosure generally relates to data processing, and, more particularly, to methods and apparatuses for implementing a platform, language, cloud, and database agnostic spot sensitivity calculating module configured to calculate real-time spot price volatility surface prediction data for any derivative instrument.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Equity index volatility surfaces have changed in the past decade. The usual convex smile shape has disappeared, and one now observes a “double moustache” on most indices. This could be seen as an evidence that customer flows are directly reflected in the volatility surface and that market makers anticipate incoming customer activity. As spot moves, both the existing market makers positions and the customers business change in nature and one observes moves in the volatility surface that may not be explained with only the traditional models. Conventional tools fail to understand and predict surface dynamics.

For example, equity derivatives desk manages portfolio delta risk using a combination of Black Scholes Greeks calculation and volatility surface inferred dynamics. A good estimation of spot vol surface dynamics may allow the desk to cheaply hedge Vega risk via delta. Vega measures the risk of changes in implied volatility or the forward-looking expected volatility of the underlying asset price. While delta measures actual price changes, Vega is focused on changes in expectations for future volatility. Traditional methodology may use “stickiness” models which presume the shape of vol surface is invariant in some strike space as the underlying spot moves, potentially missing impacts from more complex market dynamics.

### SUMMARY

The present disclosure, through one or more of its various aspects, embodiments, and/or specific features or sub-components, provides, among other features, various systems, servers, devices, methods, media, programs, and platforms for implementing a platform, language, cloud, and database agnostic spot sensitivity calculating module configured to calculate real-time (i.e., within less than two milliseconds, but the disclosure is not limited thereto) spot price volatility surface prediction data for any derivative instrument, but the disclosure is not limited thereto.

For example, the present disclosure, through one or more of its various aspects, embodiments, and/or specific features or sub-components, provides, among other features, various systems, servers, devices, methods, media, programs, and platforms for implementing a platform, language, cloud, and database agnostic spot sensitivity calculating module configured to effect the following technical improvements: implementing deep learning based machinery for delta hedging in the industry; implementing methodology to deal with intraday hedging, etc., but the disclosure is not limited thereto.

Intraday market microstructure could be vastly different from end of day observations. According to exemplary embodiments, the deep learning approach implemented by the spot sensitivity calculating module may naturally lend itself to adapt to a fast-moving market environment. Furthermore, in the event of expanding model training for global indices to single names, additional features that are idiosyncratic to company sectors may be introduced easily due to platform agnostic nature of the spot sensitivity calculating module. For example, deep learning model implemented by the spot sensitivity calculating module may be configured to change how derivative trading desks hedge their primary risk factor (delta) and how desk level risk limit should be set.

According to exemplary embodiments, a method for data processing by utilizing one or more processors along with allocated memory is disclosed. The method may include: accessing a database that stores a plurality of historical data and input data corresponding to a derivative instrument; implementing an artificial intelligence deep learning model; training the artificial intelligence deep learning model with the historical data and the input data corresponding to the derivative instrument for time-series data prediction; learning, in response to training, volatility surface deformation data over time corresponding to the derivative instrument; calculating spot sensitivity data of the derivative instrument based on the volatility surface deformation data output from the artificial intelligence deep learning model; displaying the spot sensitivity data onto a user interface; and receiving user input via the user interface to conduct a transaction with respect to the derivative instrument.

According to exemplary embodiments, in calculating spot sensitivity data, the method may further include: implementing an algorithm to capture volatility surface dynamics data corresponding to the derivative instrument.

According to exemplary embodiments, the artificial intelligence deep learning model may be a recurrent neural network model.

According to exemplary embodiments, the method may further include: implementing feedback loop to allow strike-wise dynamic corresponding to the derivative instrument; and inputting variable length sequences as the input data.

According to exemplary embodiments, the database may be a position service that stores position service data corresponding to the derivative instrument.

According to exemplary embodiments, the database may be a market data service that stores market data corresponding to the derivative instrument.

According to exemplary embodiments, the method may further include: applying bidirectional gate recurrent unit neural network algorithm; and outputting, in response to applying the bidirectional gate recurrent unit neural network algorithm, implied volatility dynamics data corresponding to the derivative instrument.

According to exemplary embodiments, a system for data processing is disclosed. The system may include: a processor; and a memory operatively connected to the processor via a communication interface, the memory storing computer readable instructions, when executed, may cause the processor to: access a database that stores a plurality of historical data and input data corresponding to a derivative instrument; implement an artificial intelligence deep learning model; train the artificial intelligence deep learning model with the historical data and the input data corresponding to the derivative instrument for time-series data prediction; learn, in response to training, volatility surface deformation data over time corresponding to the derivative instrument; calculate spot sensitivity data of the derivative instrument based on the volatility surface deformation data output from the artificial intelligence deep learning model; display the spot sensitivity data onto a user interface; and receive user input via the user interface to conduct a transaction with respect to the derivative instrument.

According to exemplary embodiments, in calculating spot sensitivity data, the processor may be further configured to: implement an algorithm to capture volatility surface dynamics data corresponding to the derivative instrument.

According to exemplary embodiments, the processor may be further configured to: implement feedback loop to allow strike-wise dynamic corresponding to the derivative instrument; and inputting variable length sequences as the input data.

According to exemplary embodiments, the processor may be further configured to: apply bidirectional gate recurrent unit neural network algorithm; and output, in response to applying the bidirectional gate recurrent unit neural network algorithm, implied volatility dynamics data corresponding to the derivative instrument.

According to exemplary embodiments, a non-transitory computer readable medium configured to store instructions for data processing is disclosed. The instructions, when executed, may cause a processor to perform the following: accessing a database that stores a plurality of historical data and input data corresponding to a derivative instrument; implementing an artificial intelligence deep learning model; training the artificial intelligence deep learning model with the historical data and the input data corresponding to the derivative instrument for time-series data prediction; learning, in response to training, volatility surface deformation data over time corresponding to the derivative instrument; calculating spot sensitivity data of the derivative instrument based on the volatility surface deformation data output from the artificial intelligence deep learning model; displaying the spot sensitivity data onto a user interface; and receiving user input via the user interface to conduct a transaction with respect to the derivative instrument.

According to exemplary embodiments, in calculating spot sensitivity data, the instructions, when executed, may cause the processor to further perform the following: implementing an algorithm to capture volatility surface dynamics data corresponding to the derivative instrument.

According to exemplary embodiments, the instructions, when executed, may cause the processor to further perform the following: implementing feedback loop to allow strike-wise dynamic corresponding to the derivative instrument; and inputting variable length sequences as the input data.

According to exemplary embodiments, the instructions, when executed, may cause the processor to further perform the following: applying bidirectional gate recurrent unit neural network algorithm; and outputting, in response to applying the bidirectional gate recurrent unit neural network algorithm, implied volatility dynamics data corresponding to the derivative instrument.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform, language, database, and cloud agnostic spot sensitivity calculating module configured to calculate real-time spot price volatility surface prediction data for any derivative instrument in accordance with an exemplary embodiment.

FIG. 2 illustrates an exemplary diagram of a network environment with a platform, language, database, and cloud agnostic spot sensitivity calculating device in accordance with an exemplary embodiment.

FIG. 3 illustrates a system diagram for implementing a platform, language, database, and cloud agnostic spot sensitivity calculating device having a platform, language, database, and cloud agnostic spot sensitivity calculating module in accordance with an exemplary embodiment.

FIG. 4 illustrates a system diagram for implementing a platform, language, database, and cloud agnostic spot sensitivity calculating module of FIG. 3 in accordance with an exemplary embodiment.

FIG. 5 illustrates an exemplary neural network model implemented by the platform, language, database, and cloud agnostic spot sensitivity calculating module of FIG. 4 in accordance with an exemplary embodiment.

FIG. 6 illustrates an exemplary flow chart of a process implemented by the platform, language, database, and cloud agnostic spot sensitivity calculating module of FIG. 4 for calculating real-time spot price volatility surface prediction data for any derivative instrument in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

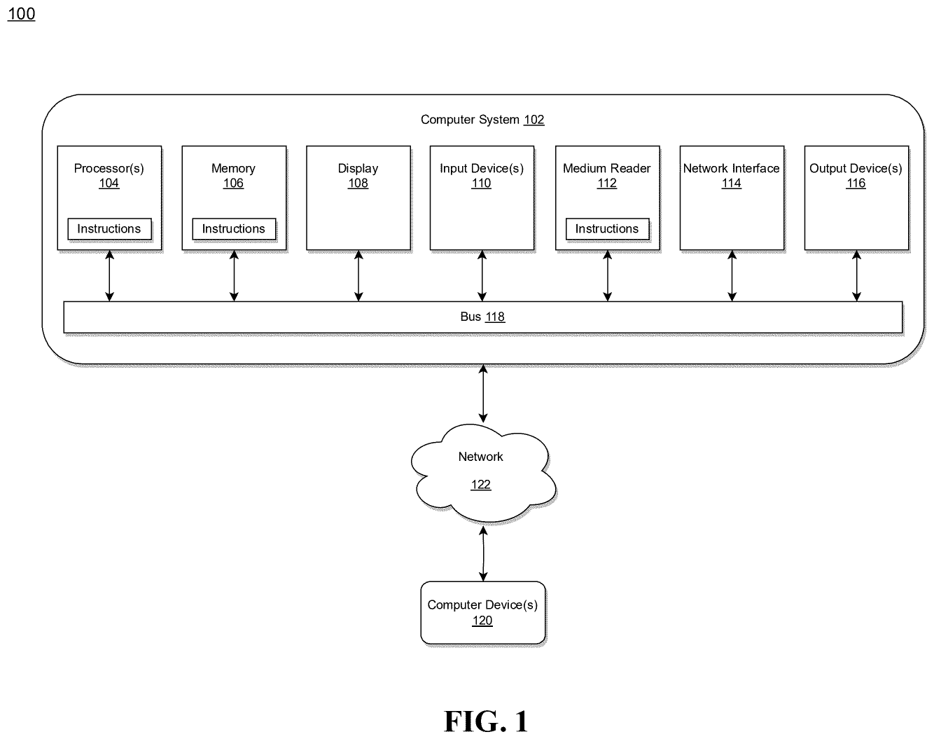

FIG. 1 is an exemplary system 100 for use in implementing a platform, language, database, and cloud agnostic spot sensitivity calculating module configured to calculate real-time spot price volatility surface prediction data for any derivative instrument in accordance with an exemplary embodiment. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

According to exemplary embodiments, the spot sensitivity calculating module implemented by the system 100 may be platform, language, database, and cloud agnostic that may allow for consistent easy orchestration and passing of data through various components to output a desired result regardless of platform, browser, language, database, and cloud environment. Since the disclosed process, according to exemplary embodiments, is platform, language, database, browser, and cloud agnostic, the spot sensitivity calculating module may be independently tuned or modified for optimal performance without affecting the configuration or data files. The configuration or data files, according to exemplary embodiments, may be written using JSON, but the disclosure is not limited thereto. For example, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionality as described herein, and a processor described herein may be used to support a virtual processing environment.

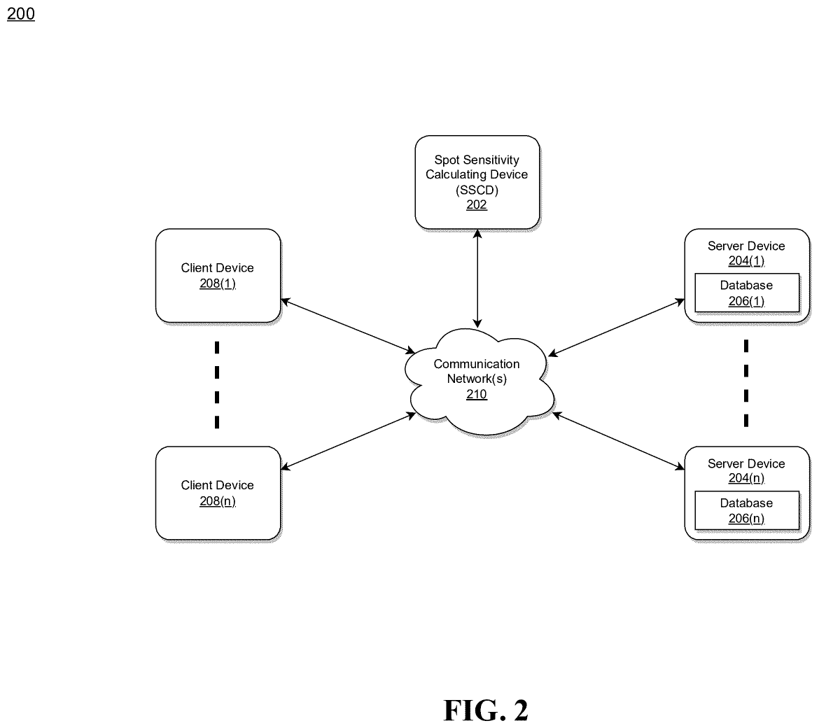

Referring to FIG. 2, a schematic of an exemplary network environment 200 for implementing a language, platform, database, and cloud agnostic spot sensitivity calculating device (SSCD) of the instant disclosure is illustrated.

According to exemplary embodiments, the above-described problems associated with conventional tools may be overcome by implementing an SSCD 202 as illustrated in FIG. 2 that may be configured for implementing a platform, language, database, and cloud agnostic spot sensitivity calculating module configured to calculate real-time spot price volatility surface prediction data for any derivative instrument, but the disclosure is not limited thereto.

The SSCD 202 may have one or more computer system 102s, as described with respect to FIG. 1, which in aggregate provide the necessary functions.

The SSCD 202 may store one or more applications that can include executable instructions that, when executed by the SSCD 202, cause the SSCD 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the SSCD 202 itself, may be located in virtual server(s) running in a cloud-based computing environment rather than being tied to one or more specific physical network computing devices. Also, the application(s) may be running in one or more virtual machines (VMs) executing on the SSCD 202. Additionally, in one or more embodiments of this technology, virtual machine(s) running on the SSCD 202 may be managed or supervised by a hypervisor.

In the network environment 200 of FIG. 2, the SSCD 202 is coupled to a plurality of server devices 204(1)-204(n) that hosts a plurality of databases 206(1)-206(n), and also to a plurality of client devices 208(1)-208(n) via communication network(s) 210. A communication interface of the SSCD 202, such as the network interface 114 of the computer system 102 of FIG. 1, operatively couples and communicates between the SSCD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the SSCD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The SSCD 202 may be a standalone device or integrated with one or more other devices or apparatuses, such as one or more of the server devices 204(1)-204(n), for example. In one particular example, the SSCD 202 may be hosted by one of the server devices 204(1)-204(n), and other arrangements are also possible. Moreover, one or more of the devices of the SSCD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the SSCD 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the SSCD 202 that may efficiently provide a platform for implementing a platform, language, database, and cloud agnostic spot sensitivity calculating module configured to calculate real-time spot price volatility surface prediction data for any derivative instrument, but the disclosure is not limited thereto.

The client devices 208(1)-208(n) may run interface applications, such as standard web browsers or standalone client applications, which may provide an interface to communicate with the SSCD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the SSCD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the SSCD 202, the server devices 204(1)-204(n), or the client devices 208(1)-208(n), for example, may be configured to operate as virtual instances on the same physical machine. For example, one or more of the SSCD 202, the server devices 204(1)-204(n), or the client devices 208(1)-208(n) may operate on the same physical device rather than as separate devices communicating through communication network(s) 210. Additionally, there may be more or fewer SSCDs 202, server devices 204(1)-204(n), or client devices 208(1)-208(n) than illustrated in FIG. 2. According to exemplary embodiments, the SSCD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

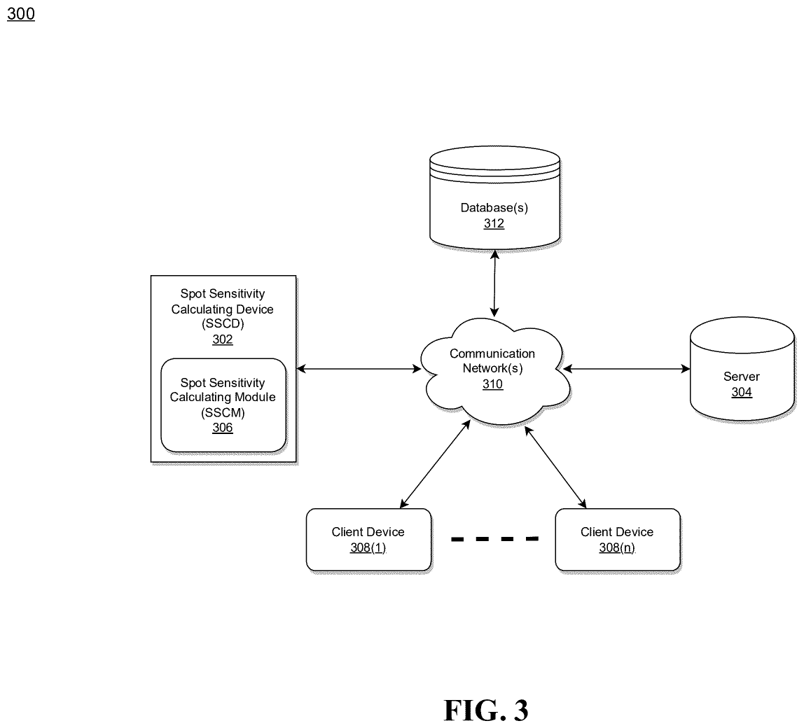

FIG. 3 illustrates a system diagram for implementing a platform, language, and cloud agnostic SSCD having a platform, language, database, and cloud agnostic spot sensitivity calculating module (SSCM) in accordance with an exemplary embodiment.

As illustrated in FIG. 3, the system 300 may include an SSCD 302 within which an SSCM 306 is embedded, a server 304, a database(s) 312, a plurality of client devices 308(1) . . . 308(n), and a communication network 310.

According to exemplary embodiments, the SSCD 302 including the SSCM 306 may be connected to the server 304, and the database(s) 312 via the communication network 310. The SSCD 302 may also be connected to the plurality of client devices 308(1) . . . 308(n) via the communication network 310, but the disclosure is not limited thereto. The database(s) 312 may include rule database.

According to exemplary embodiment, the SSCD 302 is described and shown in FIG. 3 as including the SSCM 306, although it may include other rules, policies, modules, databases, or applications, for example. According to exemplary embodiments, the database(s) 312 may be configured to store ready to use modules written for each API for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto. In addition, the database(s) 312 may store the large code bases models as directed graphs and graph metrics and graph centrality measures.

According to exemplary embodiments, the SSCM 306 may be configured to receive real-time feed of data from the plurality of client devices 308(1) . . . 308(n) and secondary sources via the communication network 310.

As may be described below, the SSCM 306 may be configured to: access a database that stores a plurality of historical data and input data corresponding to a derivative instrument; implement an artificial intelligence deep learning model; train the artificial intelligence deep learning model with the historical data and the input data corresponding to the derivative instrument for time-series data prediction; learn, in response to training, volatility surface deformation data over time corresponding to the derivative instrument; calculate spot sensitivity data of the derivative instrument based on the volatility surface deformation data output from the artificial intelligence deep learning model; display the spot sensitivity data onto a user interface; and receive user input via the user interface to conduct a transaction with respect to the derivative instrument, but the disclosure is not limited thereto.

The plurality of client devices 308(1) . . . 308(n) are illustrated as being in communication with the SSCD 302. In this regard, the plurality of client devices 308(1) . . . 308(n) may be “clients” (e.g., customers) of the SSCD 302 and are described herein as such. Nevertheless, it is to be known and understood that the plurality of client devices 308(1) . . . 308(n) need not necessarily be “clients” of the SSCD 302, or any entity described in association therewith herein. Any additional or alternative relationship may exist between either or both of the plurality of client devices 308(1) . . . 308(n) and the SSCD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the plurality of client devices 308(1) . . . 308(n) may communicate with the SSCD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The SSCD 302 may be the same or similar to the SSCD 202 as described with respect to FIG. 2, including any features or combination of features described with respect thereto.

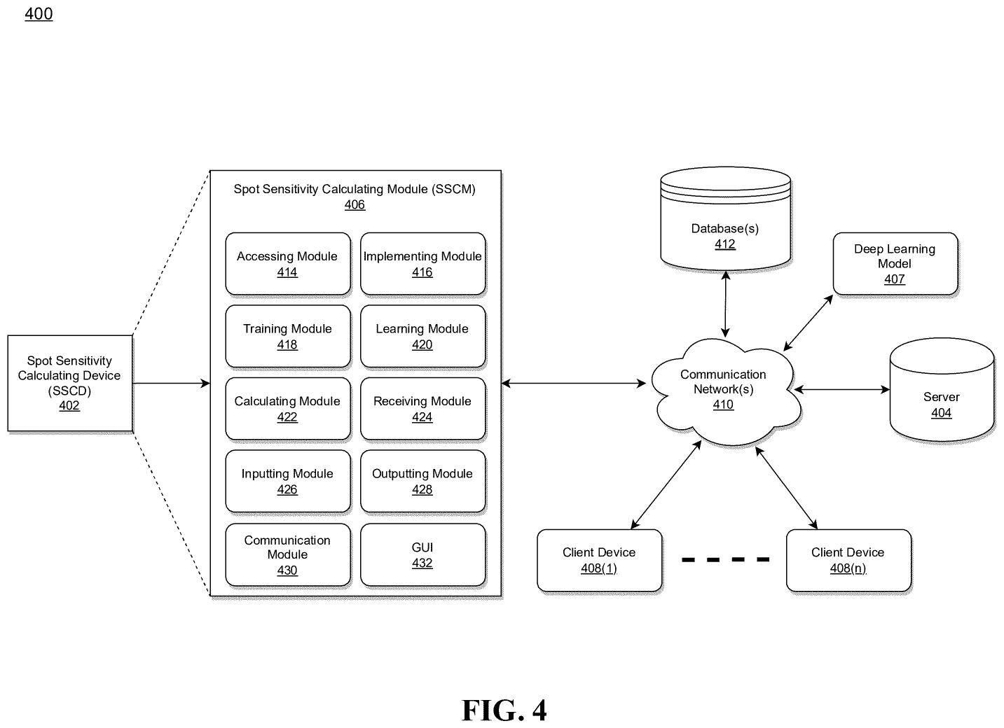

FIG. 4 illustrates a system diagram for implementing a platform, language, database, and cloud agnostic SSCM of FIG. 3 in accordance with an exemplary embodiment.

According to exemplary embodiments, the system 400 may include a platform, language, database, and cloud agnostic SSCD 402 within which a platform, language, database, and cloud agnostic SSCM 406 is embedded, a server 404, database(s) 412, and a communication network 410. According to exemplary embodiments, server 404 may comprise a plurality of servers located centrally or located in different locations, but the disclosure is not limited thereto.

According to exemplary embodiments, the SSCD 402 including the SSCM 406 may be connected to the server 404, a deep learning model 407, and the database(s) 412 via the communication network 410. The SSCD 402 may also be connected to the plurality of client devices 408(1)-408(n) via the communication network 410, but the disclosure is not limited thereto. The SSCM 406, the server 404, the plurality of client devices 408(1)-408(n), the database(s) 412, the communication network 410 as illustrated in FIG. 4 may be the same or similar to the SSCM 306, the server 304, the plurality of client devices 308(1)-308(n), the database(s) 312, the communication network 310, respectively, as illustrated in FIG. 3.

According to exemplary embodiments, the SSCM 406 may be configured to calculate real-time spot price volatility surface prediction data for any derivative instrument, but the disclosure is not limited thereto.

For example, the SSCM 406 may be configured to result the following technical improvements: implementing deep learning based machinery for delta hedging in the industry; implementing methodology to deal with intraday hedging, etc., but the disclosure is not limited thereto.

Intraday market microstructure could be vastly different from end of day observations. According to exemplary embodiments, the deep learning approach implemented by the SSCM 406 may naturally lend itself to adapt to a fast-moving market environment. Furthermore, in the event of expanding model training for global indices to single names, additional features that are idiosyncratic to company sectors may be introduced easily due to platform agnostic nature of the spot sensitivity calculating module. For example, deep learning model 407 implemented by the SSCM 406 may be configured to change how derivative trading desks hedge their primary risk factor (delta) and how desk level risk limit should be set.

Details of the SSCM 406 is provided below with corresponding modules that may be configured to, in combination, results in calculating real-time spot price volatility surface prediction data for any derivative instrument, as illustrated in FIGS. 4-6.

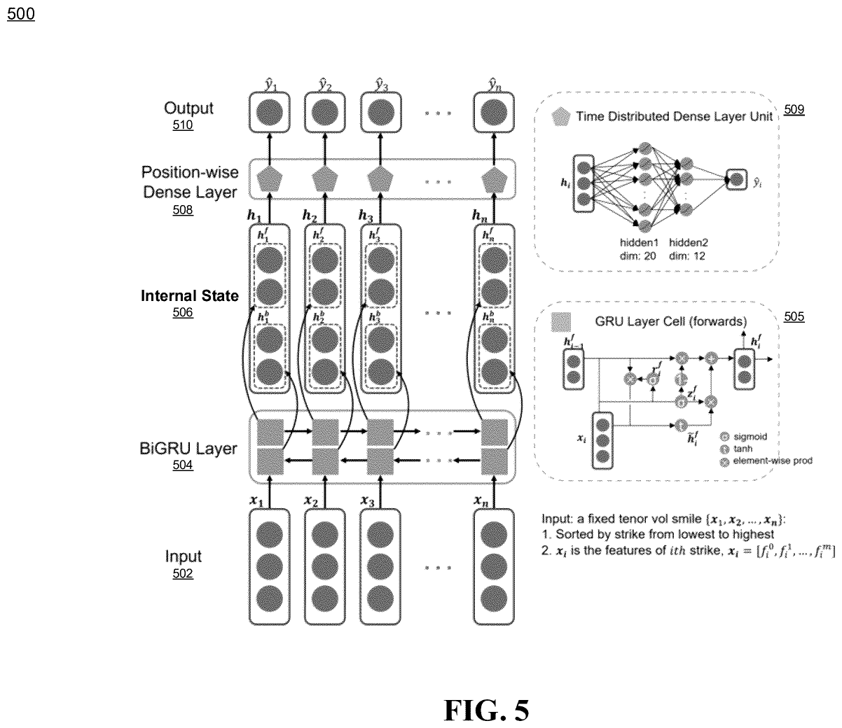

According to exemplary embodiments, as illustrated in FIG. 4, the SSCM 406 may include an accessing module 414, an implementing module 416, a training module 418, a learning module 420, a calculating module 422, a receiving module 424, an inputting module 426, an outputting module 428, a communication module 430, and a GUI 432. According to exemplary embodiments, interactions and data exchange among these modules included in the SSCM 406 provide the advantageous effects of the disclosed invention. Functionalities of each module of FIG. 4 may be described in detail below with reference to FIGS. 5-7.

According to exemplary embodiments, each of the accessing module 414, implementing module 416, training module 418, learning module 420, calculating module 422, receiving module 424, inputting module 426, outputting module 428, and the communication module 430 of the SSCM 406 of FIG. 4 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

According to exemplary embodiments, each of the accessing module 414, implementing module 416, training module 418, learning module 420, calculating module 422, receiving module 424, inputting module 426, outputting module 428, and the communication module 430 of the SSCM 406 of FIG. 4 may be implemented by microprocessors or similar, and may be programmed using software (e.g., microcode) to perform various functions discussed herein and may optionally be driven by firmware and/or software.

Alternatively, according to exemplary embodiments, each of the accessing module 414, implementing module 416, training module 418, learning module 420, calculating module 422, receiving module 424, inputting module 426, outputting module 428, and the communication module 430 of the SSCM 406 of FIG. 4 may be implemented by dedicated hardware, or as a combination of dedicated hardware to perform some functions and a processor (e.g., one or more programmed microprocessors and associated circuitry) to perform other functions, but the disclosure is not limited thereto. For example, the SSCM 406 of FIG. 4 may also be implemented by Cloud based deployment.

According to exemplary embodiments, each of the accessing module 414, implementing module 416, training module 418, learning module 420, calculating module 422, receiving module 424, inputting module 426, outputting module 428, and the communication module 430 of the SSCM 406 of FIG. 4 may be called via corresponding API, but the disclosure is not limited thereto.

According to exemplary embodiments, the process implemented by the SSCM 406 may be executed via the communication module 430 and the communication network 410, which may comprise plural networks as described above. For example, in an exemplary embodiment, the various components of the SSCM 406 may communicate with the server 404, and the database(s) 412 via the communication module 430 and the communication network 410 and the results (i.e., output 510 as illustrated in FIG. 5) may be displayed onto the GUI 432. Of course, these embodiments are merely exemplary and are not limiting or exhaustive. The database(s) 412 may include the databases included within the private cloud and/or public cloud and the server 404 may include one or more servers within the private cloud and the public cloud.

According to exemplary embodiments, the accessing module 414 may be configured to access the database(s) 412 that stores a plurality of historical data and input data corresponding to a derivative instrument. The implementing module 416 may be configured to implement an artificial intelligence deep learning model (i.e., the deep learning model 407). The training module 418 may be configured to train the artificial intelligence deep learning model with the historical data and the input data corresponding to the derivative instrument for time-series data prediction.

According to exemplary embodiments, the learning module 420 may be configured to learn, in response to training, volatility surface deformation data over time corresponding to the derivative instrument. The calculating module 422 may be configured to calculate spot sensitivity data of the derivative instrument based on the volatility surface deformation data output from the artificial intelligence deep learning model. The GUI 432 may display the spot sensitivity data onto a user interface; and the receiving module 424 may be configured to receive user input via the user interface to conduct a transaction with respect to the derivative instrument.

According to exemplary embodiments, in calculating spot sensitivity data, the implementing module 416 may be further configured to implement an algorithm to capture volatility surface dynamics data corresponding to the derivative instrument.

According to exemplary embodiments, the artificial intelligence deep learning model may be a recurrent neural network model as illustrated in FIG. 5. For example, FIG. 5 illustrates an exemplary neural network model 500 implemented by the SSCM 406 of FIG. 4 in accordance with an exemplary embodiment.

As illustrated in FIG. 5, the exemplary neural network model 500 may implement a feedback loop to allow strike-wise dynamic corresponding to the derivative instrument; and input variable length sequences as the input data (i.e., input 502). At the input layer, a fixed tenor volatility smile may include the following: X=[x₁, x₂, . . . , xₙ], X∈ [symbol] ^{n×d}, for each xᵢ, xᵢ∈R^{d} and xᵢ=[fᵢ⁰, fᵢ¹, . . . , fᵢ^{d}], and fᵢ^{j}∈R, where xᵢ is a vector of features and fᵢ^{j} is one of the features,
i) sorted by strike from lowest to highest; ii) xᵢ is the features of ith strike, [fᵢ⁰, fᵢ¹, . . . , fᵢ^{d}].

According to exemplary embodiments, a volatility smile is a common graph shape that results from plotting the strike price and implied volatility of a group of options with the same underlying asset and expiration date. The volatility smile is so named because it looks like a smiling mouth. Implied volatility rises when an option with strike price further out of the money (OTM), or in the money (ITM) has higher or lower volatility, compared to at the money (ATM) option.

Referring back to FIGS. 4 and 5, according to exemplary embodiments, the database(s) 412 may include a position service that stores position service data corresponding to the derivative instrument and a market data service that stores market data corresponding to the derivative instrument. The position service and the market data service may be operatively connected to an artificial intelligence delta calculation engine within the deep learning model 407 to receive, by utilizing the receiving module 424, corresponding data from each of the market data service and the position service to output results (i.e., output 510 as illustrated in FIG. 5), by utilizing the outputting module 428 to a portfolio analytics user interface for receiving user input corresponding to one or more transactions with respect to the derivative instrument.

According to exemplary embodiments, the implementing module 416 may be further configured to apply bidirectional gate recurrent unit neural network algorithm; and the outputting module 428 may be configured to output, in response to applying the bidirectional gate recurrent unit neural network algorithm, implied volatility dynamics data corresponding to the derivative instrument.

For example, as illustrated in FIG. 5, input 502 may be received by the bidirectional gate recurrent unit (BiGRU) layer 504 of the neural network model 500. The BiGRU layer 504 may include a plurality of GRU layer cells. An exemplary GRU layer cell (forwards) 505 is illustrated in FIG. 5 where the following computations are performed: hᵢ internal states from GRUs, where each encodes all observations i∈[1, i], input into next unit hᵢ₊₁. An exemplary GRU layer cell (forwards) is represented below:

$${r}_{i}^{f} = sigmoid ( {W}_{r} {x}_{i}^{f} + {U}_{r} {h}_{i - 1}^{f} + {b}_{r}^{f} ) ,$$

$${z}_{i}^{f} = sigmoid ( {W}_{z} {x}_{i}^{f} + {U}_{z} {h}_{i - 1}^{f} + {b}_{z}^{f} ) ,$$

$${\hat{h}}_{i}^{f} = tanh ( {W}_{h} {x}_{i}^{f} + {U}_{h} ( {r}_{i}^{f} ⊙ {h}_{i - 1}^{f} ) + {b}_{h}^{f} ,$$

$${h}_{i}^{f} = {z}_{i}^{f} ⊙ {\hat{h}}_{i}^{f} + ( 1 - {z}_{i}^{f} ) ⊙ {h}_{i - 1}^{f} .$$

Concatenate forward and backward hidden states may be represented as hᵢ=Concat(hᵢ^{f}, hᵢ^{b}).

As illustrated in FIG. 5, data from the BiGRU layer 504 may flow to an internal state 506 of the exemplary neural network model 500. Data from the internal state 506 may flow to a position-wise dense layer 508 of the exemplary neural network model 500. The position-wise dense layer 508 may include a plurality of time distributed dense layer unit 509. At this stage, the exemplary neural network model 500 may implement multi-layer perception (MLP) algorithm to generate output 510 as follows: ŷᵢ=Dense(hᵢ).

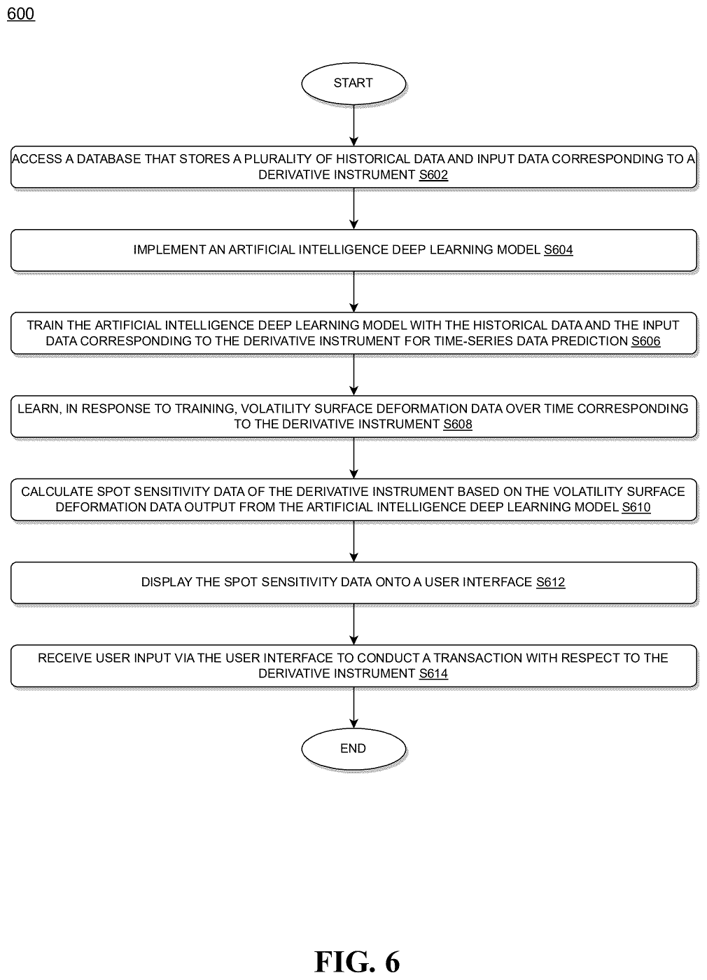

FIG. 6 illustrates an exemplary flow chart of a process 600 implemented by the platform, language, database, and cloud agnostic SSCM 406 of FIG. 4 for calculating real-time spot price volatility surface prediction data for any derivative instrument in accordance with an exemplary embodiment. It may be appreciated that the illustrated process 600 and associated steps may be performed in a different order, with illustrated steps omitted, with additional steps added, or with a combination of reordered, combined, omitted, or additional steps.

As illustrated in FIG. 6, at step S602, the process 600 may include accessing a database that stores a plurality of historical data and input data corresponding to a derivative instrument.
At step S604, the process 600 may include implementing an artificial intelligence deep learning model.
At step S606, the process 600 may include training the artificial intelligence deep learning model with the historical data and the input data corresponding to the derivative instrument for time-series data prediction.
At step S608, the process 600 may include learning, in response to training, volatility surface deformation data over time corresponding to the derivative instrument.
At step S610, the process 600 may include calculating spot sensitivity data of the derivative instrument based on the volatility surface deformation data output from the artificial intelligence deep learning model.
At step S612, the process 600 may include displaying the spot sensitivity data onto a user interface.
At step S614, the process 600 may include receiving user input via the user interface to conduct a transaction with respect to the derivative instrument.

According to exemplary embodiments, in calculating spot sensitivity data, the process 600 may further include: implementing an algorithm to capture volatility surface dynamics data corresponding to the derivative instrument.

According to exemplary embodiments, in the process 600, the artificial intelligence deep learning model may be a recurrent neural network model, but the disclosure is not limited thereto.

According to exemplary embodiments, the process 600 may further include: implementing feedback look to allow strike-wise dynamic corresponding to the derivative instrument; and inputting variable length sequences as the input data.

According to exemplary embodiments, in the process 600, the database may be a position service that stores position service data corresponding to the derivative instrument.

According to exemplary embodiments, in the process 600, the database may also be a market data service that stores market data corresponding to the derivative instrument.

According to exemplary embodiments, the process 600 may further include: applying bidirectional gate recurrent unit neural network algorithm; and outputting, in response to applying the bidirectional gate recurrent unit neural network algorithm, implied volatility dynamics data corresponding to the derivative instrument.

According to exemplary embodiments, the SSCD 402 may include a memory (e.g., a memory 106 as illustrated in FIG. 1) which may be a non-transitory computer readable medium that may be configured to store instructions for implementing a platform, language, database, and cloud agnostic SSCM 406 for automatically and dynamically calculating real-time spot price volatility surface prediction data for any derivative instrument as disclosed herein. The SSCD 402 may also include a medium reader (e.g., a medium reader 112 as illustrated in FIG. 1) which may be configured to read any one or more sets of instructions, e.g., software, from any of the memories described herein. The instructions, when executed by a processor embedded within the SSCM 406 or within the SSCD 402, may be used to perform one or more of the methods and processes as described herein. In a particular embodiment, the instructions may reside completely, or at least partially, within the memory 106, the medium reader 112, and/or the processor 104 (see FIG. 1) during execution by the SSCD 402.

According to exemplary embodiments, the instructions, when executed, may cause a processor embedded within the SSCM 406 or the SSCD 402 to perform the following: accessing a database that stores a plurality of historical data and input data corresponding to a derivative instrument; implementing an artificial intelligence deep learning model; training the artificial intelligence deep learning model with the historical data and the input data corresponding to the derivative instrument for time-series data prediction; learning, in response to training, volatility surface deformation data over time corresponding to the derivative instrument; calculating spot sensitivity data of the derivative instrument based on the volatility surface deformation data output from the artificial intelligence deep learning model; displaying the spot sensitivity data onto a user interface; and receiving user input via the user interface to conduct a transaction with respect to the derivative instrument. According to exemplary embodiments, the processor may be the same or similar to the processor 104 as illustrated in FIG. 1 or the processor embedded within the SSCD 202, SSCD 302, SSCD 402, and SSCM 406 which is the same or similar to the processor 104.

According to exemplary embodiments, in calculating spot sensitivity data, the instructions, when executed, may cause the processor 104 to further perform the following: implementing an algorithm to capture volatility surface dynamics data corresponding to the derivative instrument.

According to exemplary embodiments, the instructions, when executed, may cause the processor 104 to further perform the following: implementing feedback look to allow strike-wise dynamic corresponding to the derivative instrument; and inputting variable length sequences as the input data.

According to exemplary embodiments, the instructions, when executed, may cause the processor 104 to further perform the following: applying bidirectional gate recurrent unit neural network algorithm; and outputting, in response to applying the bidirectional gate recurrent unit neural network algorithm, implied volatility dynamics data corresponding to the derivative instrument.

According to exemplary embodiments as disclosed above in FIGS. 1-6, technical improvements effected by the instant disclosure may include a platform for implementing a platform, language, database, and cloud agnostic spot sensitivity calculating module configured to calculate real-time (i.e., within less than two milliseconds, but the disclosure is not limited thereto) spot price volatility surface prediction data for any derivative instrument, but the disclosure is not limited thereto.

According to exemplary embodiments as disclosed above in FIGS. 1-6, technical improvements effected by the instant disclosure may include a platform for implementing a platform, language, database, and cloud agnostic spot sensitivity calculating module configured to result the following technical improvements: implementing deep learning based machinery for delta hedging in the industry; implementing methodology to deal with intraday hedging, etc., but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for data processing by utilizing one or more processors along with allocated memory, the method comprising:
accessing a database that stores a plurality of historical data and input data corresponding to a derivative instrument;
implementing an artificial intelligence deep learning model;
training the artificial intelligence deep learning model with the historical data and the input data corresponding to the derivative instrument for time-series data prediction;
learning, in response to training, volatility surface deformation data over time corresponding to the derivative instrument;
calculating spot sensitivity data of the derivative instrument based on the volatility surface deformation data output from the artificial intelligence deep learning model;
displaying the spot sensitivity data onto a user interface; and
receiving user input via the user interface to conduct a transaction with respect to the derivative instrument.

2. The method according to claim 1, in calculating spot sensitivity data, the method further comprising:
implementing an algorithm to capture volatility surface dynamics data corresponding to the derivative instrument.

3. The method according to claim 1, wherein the artificial intelligence deep learning model is a recurrent neural network model.

4. The method according to claim 3, further comprising:
implementing feedback loop to allow strike-wise dynamic corresponding to the derivative instrument; and
inputting variable length sequences as the input data.

5. The method according to claim 1, wherein the database is a position service that stores position service data corresponding to the derivative instrument.

6. The method according to claim 1, wherein the database is a market data service that stores market data corresponding to the derivative instrument.

7. The method according to claim 1, further comprising:
applying bidirectional gate recurrent unit neural network algorithm; and
outputting, in response to applying the bidirectional gate recurrent unit neural network algorithm, implied volatility dynamics data corresponding to the derivative instrument.

8. A system for data processing, the system comprising:
a processor; and
a memory operatively connected to the processor via a communication interface, the memory storing computer readable instructions, when executed, causes the processor to:
access a database that stores a plurality of historical data and input data corresponding to a derivative instrument;
implement an artificial intelligence deep learning model;
train the artificial intelligence deep learning model with the historical data and the input data corresponding to the derivative instrument for time-series data prediction;
learn, in response to training, volatility surface deformation data over time corresponding to the derivative instrument;
calculate spot sensitivity data of the derivative instrument based on the volatility surface deformation data output from the artificial intelligence deep learning model;
display the spot sensitivity data onto a user interface; and
receive user input via the user interface to conduct a transaction with respect to the derivative instrument.

9. The system according to claim 8, in calculating spot sensitivity data, the processor is further configured to:
implement an algorithm to capture volatility surface dynamics data corresponding to the derivative instrument.

10. The system according to claim 8, wherein the artificial intelligence deep learning model is a recurrent neural network model.

11. The system according to claim 10, wherein the processor is further configured to:
implement feedback loop to allow strike-wise dynamic corresponding to the derivative instrument; and
input variable length sequences as the input data.

12. The system according to claim 8, wherein the database is a position service that stores position service data corresponding to the derivative instrument.

13. The system according to claim 8, wherein the database is a market data service that stores market data corresponding to the derivative instrument.

14. The system according to claim 8, wherein the processor is further configured to:
apply bidirectional gate recurrent unit neural network algorithm; and
output, in response to applying the bidirectional gate recurrent unit neural network algorithm, implied volatility dynamics data corresponding to the derivative instrument.

15. A non-transitory computer readable medium configured to store instructions for data processing, the instructions, when executed, cause a processor to perform the following:
accessing a database that stores a plurality of historical data and input data corresponding to a derivative instrument;
implementing an artificial intelligence deep learning model;
training the artificial intelligence deep learning model with the historical data and the input data corresponding to the derivative instrument for time-series data prediction;
learning, in response to training, volatility surface deformation data over time corresponding to the derivative instrument;
calculating spot sensitivity data of the derivative instrument based on the volatility surface deformation data output from the artificial intelligence deep learning model;
displaying the spot sensitivity data onto a user interface; and
receiving user input via the user interface to conduct a transaction with respect to the derivative instrument.

16. The non-transitory computer readable medium according to claim 15, in calculating spot sensitivity data, the instructions, when executed, cause the processor to further perform the following:
implementing an algorithm to capture volatility surface dynamics data corresponding to the derivative instrument.

17. The non-transitory computer readable medium according to claim 15, wherein the artificial intelligence deep learning model is a recurrent neural network model.

18. The non-transitory computer readable medium according to claim 17, wherein the instructions, when executed, cause the processor to further perform the following:
implementing feedback loop to allow strike-wise dynamic corresponding to the derivative instrument; and
inputting variable length sequences as the input data.

19. The non-transitory computer readable medium according to claim 15, wherein the database includes a position service that stores position service data corresponding to the derivative instrument, and a market data service that stores market data corresponding to the derivative instrument.

20. The non-transitory computer readable medium according to claim 15, wherein the instructions, when executed, cause the processor to further perform the following:
applying bidirectional gate recurrent unit neural network algorithm; and
outputting, in response to applying the bidirectional gate recurrent unit neural network algorithm, implied volatility dynamics data corresponding to the derivative instrument.
